(19) United States
(12) Patent Application Publication
(10) Pub. No.: US 2008/0273699 A1
(43) Pub. Date: Nov. 6, 2008

(54) SYSTEM FOR CONTROLLING THE TRANSMISSION OF MASS NOTIFICATIONS

(75) Inventor: Joshua Roth, Pacific Palisades, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: NOTIFICATION TECHNOLOGIES, INC., Sherman Oaks, CA (US)

(21) Appl. No.: 11/744,187

(22) Filed: May 3, 2007

(51) Int. Cl. H04N 7/167

(52) U.S. Cl. 380/241

(57) ABSTRACT

A system for authorizing the mass distribution of a digital message includes a CPU configured to prepare in digital form a message from an initiator, and to distribute the message to a plurality of recipients and/or recipient contact devices. The CPU is further configured to associate with the message data sets selected by the initiator, and: To compare the data sets with a set of authorization criteria, whereby the CPU determines if an authorization threshold has been crossed. To distribute the message if no authorization threshold has been crossed. To wait for authorization if any authorization threshold has been crossed, and, thereafter: to distribute the message if authorization is provided; or to not distribute the message if authorization is not provided.

### BACKGROUND OF THE INVENTION

The present invention relates generally to the creation and delivery of a time sensitive message to a selected group of recipients through various communication methods. More specifically, the invention relates to a method and device for setting and utilizing authorization safeguards prior to the delivery of such a message.

Businesses and governmental entities, including municipalities and schools are ever more reliant on communicating through the mass transmission of messages to their staff, citizens and family members of students to keep them apprized of important events, and sometimes of emergencies. For example, a school principal might need to inform the parent of every student that the school will be closed the next day due to some unforeseen event such as flooding, fire, or freezing conditions. Such a message might be sent to telephones, faxes, pagers, electronic mail (e-mail), and/or text messages. Often these messages will vary in their level of importance and/or by the number of recipients. Some messages may require immediate transmission and/or to be transmitted to a large audience. For example, if the water source for a city has been contaminated at 2:00 a.m., the city may need to immediately warn all citizens of the event and inform them of steps to take to avoid any danger.

Yet, it will be appreciated that if simply anyone with access to a mass message transmission system is able to pick up the phone at 3:00 a.m. and send a message directly to hundreds of thousands of citizens, there is the potential for widespread and enormous inconvenience and even panic. In these circumstances, it is important that a system delivering a mass message have built-in accountability, and a process for screening out those who may have an illicit motive to disrupt or cause inconvenience, or those who are simply acting by mistake. The prior art systems in this field that are in use suffer the disadvantage of not possessing these safeguards.

Thus, there is a need in the art for a system and method that overcomes the shortcomings of the prior art. The present invention addresses these and other needs.

### SUMMARY OF THE INVENTION

In the case of mass distribution of a single message to perhaps thousands of recipients, it has been found that a system of checks and balances is advantageous, and even necessary, for managing the orderly transmission of such a message created by a user of the system. In a preferred embodiment of the present invention, checks and balances are enabled by interposing at least one individual, in addition to the user who created the message. That other individual is authorized to review the message, and has discretion to initiate distribution of the message, or to delay its distribution, or to block it entirely based on his personal discretionary judgment. The system of the present invention is designed to optimize and safeguard the flow of events controlled by a central processing unit (CPU) that prepares a message for mass distribution, and ultimately causes its distribution.

In a preferred embodiment, the invention is a system for authorizing the mass distribution of a digital message that comprises a CPU configured to prepare in digital form a message sent to the CPU from an initiator (or user), and to distribute the message to a plurality of recipient contact devices. The CPU is further configured to associate with the message data sets selected by the initiator. The CPU includes a database for storing the message and associated data sets. The CPU is configured to perform the following functions pending distribution of the message, including:
a. to compare the data sets with a set of authorization criteria, whereby the CPU determines if an authorization threshold has been crossed;
b. to distribute the message if no authorization threshold has been crossed; and
c. to wait for authorization by an individual if any authorization threshold has been crossed, and, thereafter:
   1. to distribute the message if authorization is provided; or
   2. to not distribute the message if authorization is not provided.

Using the above structure, the system will not distribute any message to a mass of recipients upon the mere instruction of an ordinary user of the system. Rather, the system will wait until it has been in communication with an individual who has been selected to scrutinize outgoing messages and their associated data sets, and who has been given the authority to give the final approval to mass distribution of any message based on her discretionary judgment.

In one aspect of the invention, the data sets include information relating to the type of message that is pending distribution. In another aspect, the data sets include information relating to the time the message is to be distributed. In yet another aspect, the data sets include information relating to the number of recipients to which the message is to be distributed. And in a further aspect, the data sets include information relating to the number of recipient contact devices to which the message is to be distributed.

In a preferred embodiment, the CPU is further configured to receive a communication from an authorizer (who may call in to the CPU to check if there are messages requiring authorization), in addition to sending out a message to the authorizer that messages are pending distribution. In either embodiment, the CPU is configured to request the authorizer to enter an identification code before permitting further communication. The identification code may be received by means of telephone dial entry, or by means of voice recognition software, or by means of entry into a text field on a website or application, or by means of an e-mail.

One feature of the invention is that CPU is configured to permit the authorizer to review a pending message and to review the data sets associated with the message, to allow the authorizer to exercise her discretion as to whether the message should be distributed, suspended, or blocked altogether. Should the authorizer be satisfied that the message presents no risk, the CPU is configured to allow her to initiate distribution of the message.

In a preferred aspect, the CPU is configured to permit the authorization threshold to be set by management of the system to comprise the class of information in the data sets associable with the message. Thus, in one aspect, the authorization threshold includes timing for sending the message. In another aspect, the authorization threshold includes the number of persons intended to receive the message. In yet another aspect, the authorization threshold includes classification of the persons intended to receive the message. And in an even further aspect, the authorization threshold includes classification of the type of message intended for distribution. In an alternative embodiment, the authorization threshold may comprise a combination of individual thresholds, preferably the authorization system includes at least two sets of information selected from (a) timing for sending the message, (b) the number of persons intended to receive the message, and (c) classification of the persons intended to receive the message.

These and other advantages of the invention will become more apparent from the following detailed description thereof and the accompanying exemplary drawings.

### BRIEF DESCRIPTION OF THE DRAWINGS

FIG. 1 is a schematic representation of a mass calling system having features of the present invention.

FIG. 2 is a schematic representation of logical steps taken according to aspects of the present invention.

### DETAILED DESCRIPTION OF THE PREFERRED EMBODIMENTS

With reference to the drawings, which are provided by way of exemplification and not limitation, there is disclosed a preferred embodiment of a system for controlling the creation and delivery of mass messages.

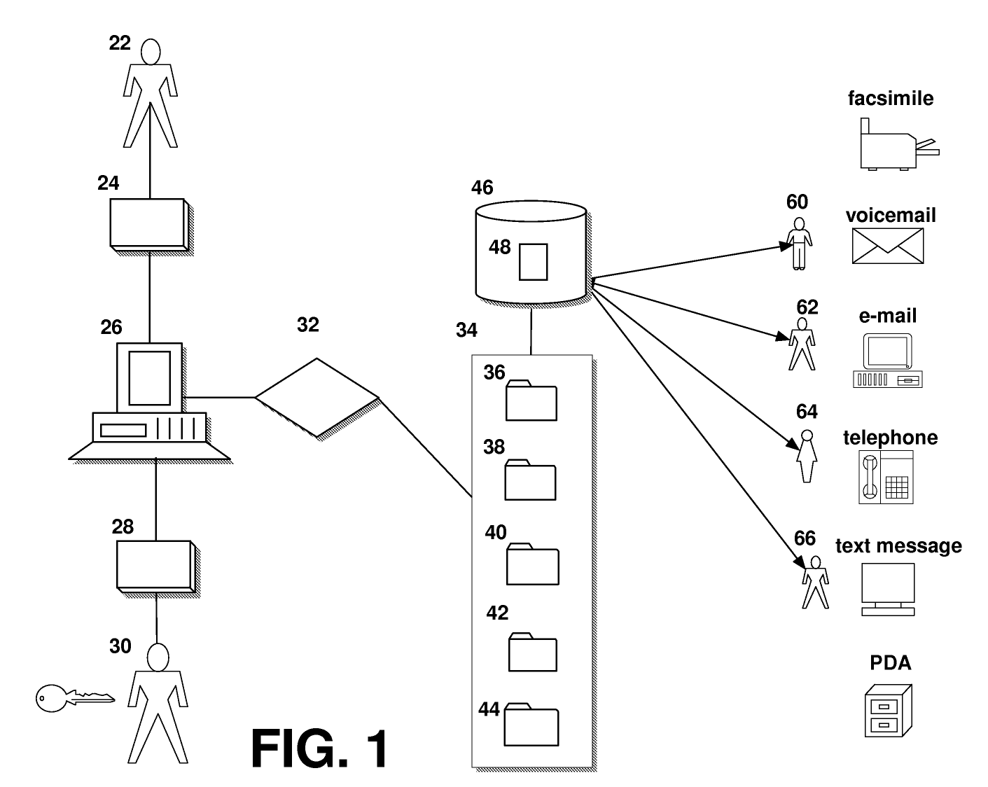

With reference to FIG. 1, a CPU or central processing unit 26 resides at the center of the system. The CPU is preconfigured to receive a message from a user 22, or initiator, of the system who may wish to send that message to a large number of recipients. The user will have acquired the right to send a message into the CPU 26 by earlier entering into a prior contract with the management of the system, entering his name on a list of legitimate users, paying the required fee if appropriate, and acquiring an entry code. The message the user sends to the CPU 26 may be sent in any one of a number of different formats via a transmission interface 24. For example the transmission interface 24 may be an ordinary land telephone, a cell phone, a computer for sending email, a computer with an internet connection, or it may be a facsimile machine for sending faxes, or the like. For example, a message might be: “Please clear your brush before fire season.” The selected recipients might be a group of residents who live within a fire zone. The time and date to send might be tonight at 7:00 pm, and the methods of transmission to recipients selected by the user might include telephone and e-mail delivery.

Once the message is received by the CPU 26, it is stored by the CPU as a message file 32 to which there is associated a transmission data file 34 for later use, as set forth more fully below. Firstly, it may be noted that if the message received is an ordinary voice message via an interface 24 which is a telephone, the analogue voice signal may be converted to a digital sound file such as a .wav file and stored in the CPU as such. If the message received via the interface 24 is an email, it may be stored in the CPU as a .txt file, but it may also be converted to a sound file using TTS (text-to-speech) software. If the message is received as facsimile, it may be stored in the CPU as a .pdf file. All of these are stored pending distribution to the appropriate recipients in the appropriate form.

Once the message file 32 is stored in the CPU, it is associated with the transmission data file 34 which is structured to include a number of data sets that will later assist in controlling the transmission of the message file 32. For example, the user may insert information into the data sets by entering key strokes (telephone key, computer key, etc) in response to queries from the CPU as to what information should be entered in the data sets. The data sets will then be associated with the message file, as described. The information in the data sets may include the following: A time set 36 contains information relating to the time the message is scheduled for distribution. A recipient set 38 contains information relating to the class of recipients the message is intended to reach. For example, the recipients may be all the parents of students at a school between 6^{th} and 8^{th} grades. A location set 40 contains information relating to the geographical location the message is intended to reach. For example, the recipients may be all the residents in a town living on one side of a river, or next to a combustible forest. Further sets may be generated from information provided in preceding sets. For example, a number set 42 may be generated by the CPU 26 from the information entered into the recipient set 40, wherein the CPU calculates the number of intended recipients of the message, and enters that number into the number set 44 for later use, as described below. A sender identity set 44 may contain the identity of the user 22 who created the message, and information relating to the status and rights of that user 22. The status and rights of the user would be obtained from the code entered by the user to access the CPU 26 in order to leave the message. For example, the user identity set 44 may indicate that the user is the principal of a school who would legitimately want to reach a large audience of parents of students at the school; or it may indicate that the user is a teacher of 8^{th} grade, who would typically want to reach only the parents of students in her 8^{th} grade class, or perhaps all the 8^{th} grade students in the school, but whose legitimate interest would not include communicating with the parents of all the students at a school.

Once the message 32 is created in the appropriate plurality of formats (e.g., .wav, .txt, or .pdf) and is associated with the transmission data file 34 with its data sets, the CPU stores the message and associated data file in a delivery interface 46. The delivery interface 46 is configured to hold the message in storage until a triggering event occurs, as more fully described below.

When such triggering event occurs, the delivery interface 46 causes the message to be distributed, according to known methods, to a mass of recipients, e.g. recipients 60-66. (FIG. 1) Within the delivery interface 46 in the CPU, each recipient of the message have already been associated with a means of transmission according to a prior request by made by each potential recipient to the management of the system. Thus, for example, recipient 60 may have requested to be associated with a means of transmission by facsimile, recipient 62 may be associated with a means of transmission by voicemail, recipient 64 may be associated with a means of transmission by e-mail, recipient 66 may be associated with a means of transmission by text message, or pager, and so on. Thus, the CPU is configured to transmit the message in appropriate format (e.g. .wav, .txt, .pdf) to each recipient, according to known method.

The result is that, once the triggering event occurs, a single message (having been delivered to the CPU 26 by an enabled user 22 possessing an access code) is eventually transmitted as a near simultaneous event, to masses of recipients identified by the user 22. This capability of the system places enormous power in the hands of an institution or group of people to keep classes of citizens informed of events that are directly relevant to them on a real time basis.

As identified above however, this capability does not come without potential risk. If it is not properly supervised, this capability also may create the potential for abuse, in which false or erroneous messages may be sent to large numbers of people to cause widespread panic or disruption before its genuineness can be verified. Thus, there is a need in the art for a system that provides scrutiny of outgoing messages, and possible suspension or cancellation where appropriate. This need is addressed according to the present invention, initially, by designating a limited number of persons to be empowered to provide final authorization, based on their discretionary judgment, for a mass transmission that would cross some predetermined threshold. Such a threshold may consist in the type of message (for example, requiring evacuation of property, near one extreme, to requiring removal of vehicles for street cleaning, near another extreme), the time of day, the absolute number of potential recipients, the percentage of recipients from a potential class, or other similar criterion, or a combination of any of these criteria.

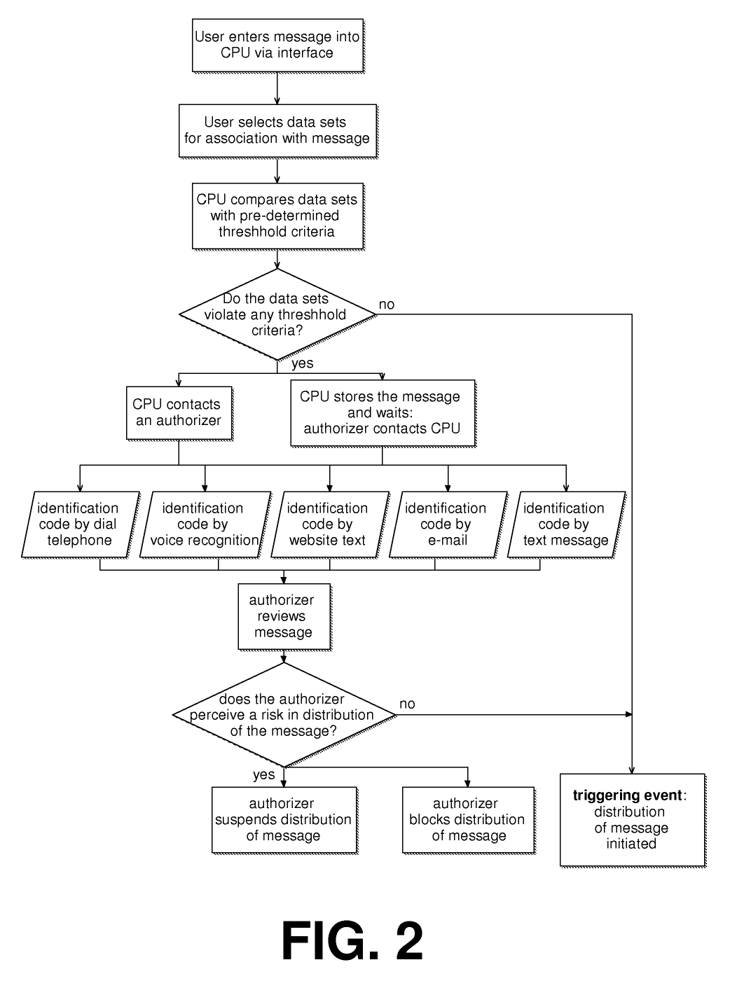

Thus, with reference to FIG. 2, there is disclosed a system with a built-in sequence of configured steps under which a preferred embodiment of the present invention may be implemented. In order to provide the appropriate control over triggering transmission of a message for a mass distribution, the CPU will include a subroutine that includes authorization criteria. The CPU will compare the data sets in the transmission file 34 against these criteria and will determine whether the message may be sent without further scrutiny, or whether a pre-designated individual must review the message in light of its data sets before authorizing transmission.

The authorization criteria subroutine 48 (FIG. 1) comprises a set of rules that determine whether the data sets meet predetermined standards. If they satisfy those standards, one triggering event has occurred, and the message is distributed. However, if not, the subroutine 48 initiates a series of steps to obtain the personal authorization of an individual that has been given the status to give such authorization. These rules may, for example, include a requirement that: no message after a certain hour of the day can go out without interventional authorization; certain types of message (e.g. property evacuation) cannot go out without interventional authorization; a message for more than a certain number, or for a certain class of recipients, must have interventional authorization. Any message that includes a data set that would violate any of these authorization criteria triggers the steps for interventional authorization.

To provide for this protection, a number of persons are identified by the management of the system to intervene in the automatic process of message transmission, and to provide or deny authority for the message to be transmitted based on their personal review and assessment of the contents of the message 32 residing in the CPU 26 pending transmittal. Such persons shall be referred to herein as authorizers 30 (FIG. 1).

Turning again to FIG. 2, when a data set associated with a message violates any of the authorization criteria, a process is initiated by the CPU 26 to contact a pre-designated authorizer 30 via an appropriate interface 28. A “duty roster” resides as a database in the CPU so that the CPU is configured to sequentially contact a number of individuals on the duty roster, depending on the time and date. The interface 28 that may be used in making such contact may be a regular telephone line, an e-mail, a text message, or other potential means. Upon making contact via the interface 28, the CPU 26 will request the authorizer 30 to provide an authorization code using text, touch tone dialing, voice recognition software, or by logging on through a website and providing the proper information. Upon entering the code, and upon the interface recognizing the correct code, the CPU may provide the authorizer with a message to the effect that: “You have messages that require authorization”—if indeed there are messages that require authorization. In an alternative embodiment, an authorizer with appropriate security code may contact the CPU 26 via the interface 28 (telephone, web, etc.) from time to time to check of his own accord whether there are messages waiting for authorization clearance. Once the authorizer is in communication with the CPU 26, the path followed is the same as if he had been contacted by the CPU.

To proceed with the authorization process, the authorizer 30 may be invited by the CPU, for example, to press a dial key on his telephone receiver, or enter a key stroke If the authorizer chooses to enter the authorization process, the CPU will communicate, via audio file or text-to-speech (“TTS”), pertinent information in the data sets 34, for example the name and status of the message creator, the number of call recipients for that call, the intended time of delivery, and any other information that may be relevant to an authorization decision by the authorizer. For example “The following call was created by [name] and, once approved, will be sent to [number of recipients] at [time of delivery] in the [time zone].” The system may then play back the message that requires authorization (either TTS, voice, or blended). Then, for example, the CPU will prompt the authorizer 30 to choose from the following: (The prompt the user hears may be based on the send date of the message, whether it is in the past or in the future, and the current time based on the time zone of record.)

If time scheduled is in the future, then, for example: “To approve this message to be sent at its scheduled delivery time, press 1. To reject this message, press 3. To postpone the approval of this message, press 4. To exit the authorization process, press 9.”

If time scheduled is in the past (which means the schedule might be sent immediately if approved, and the current time is after 9 pm and before 8 am then, for example: “To approve and send this message now, press 1. To approve and send this message at 9 a.m., press 2. To reject this message, press 3. To postpone the approval of this message, press 4. To exit the authorization process, press 9.”

Alternatively, if the time scheduled is in the past (which means the schedule might be sent immediately if approved), and the current time is after 9 pm and before 8 am then, for example: “To approve and send this message now, press 1. To reject this message, press 3. To postpone the approval of this message, press 4. To exit the authorization process, press 9.”

Further, if the authorizer approves the message, another triggering event has occurred, and the message is distributed. The system may play, for example: “Thank you. The message will be delivered as scheduled.” If the authorizer approves the message to be sent at 9 am the following morning, the system may play, for example: “Thank you. The message will be delivered at 9 am tomorrow morning.”

If the authorizer does not approve the message, the system may play, for example: “Thank you. The message has been marked as ‘not approved.’”

Furthermore, if the authorizer does not approve the message, the message may be taken out of the queue and an e-mail, phone call, text message, or other form of notification may be sent to the message creator that the message was not approved.

Additionally, the CPU may include a message log that may note that the call was disapproved, with an additional note that, for example: messages that are marked as “not approved” can not be sent again.

If the authorizer chooses to postpone a decision, the CPU may play, for example: “Thank you. This message will remain pending until approved or rejected.”

Once the authorizer makes a decision regarding a message, if there are more messages left to be authorized, the system may prompt the user with, for example, the following: “There is another message requiring authorization, to review this message, press 1, to skip this and record a new message, press 2. Pressing 1 will allow the user to continue the authorization process. Pressing 2 will take the user to the record message menu.”

If there are no messages left requiring approval, the CPU may play for example the following: “The authorization process is complete.”

If the authorizer chooses to review messages authorized in the last 24 hours, they may be played the following message (oldest message first if more than one message in the queue for approval): “A message created by [name] titled [subject] has been approved by [authorizer] on [date] at [time].”

After reviewing all messages, the authorizer may be returned to the above menu where she may be prompted to either enter authorization, listen to authorized messages, or proceed to record a new message.

Turning now to the process used by the user 22 under this aspect of the invention, a user is one who has the necessary clearance code for creating and sending a message to mass distribution. When the user chooses to record a new message for transmission, she may call via the interface 24 and obtain access to the CPU using her own authentication code. She creates her own message, and confirms the distribution list, time for sending, and any other information about the message that will be entered into the data sets in the transmission data file 34 and become associated with the message 32 in the CPU.

If the message data sets meet any of the pre-configured thresholds as defined in the authorization criteria 48, the user 22 may be played a message, for example: “Your message requires authorization before it can be sent. To continue, press 1. To cancel this schedule and exit, press 9.”

If the user chooses to continue, she may get, for example, the following message: “Please contact one of the following authorizers and request that they use their code to approve the message. You may listen to the list or hang up at any time.” (In the event the system is configured to automatically contact an authorizer, such a message will not be played.)

The system then may read the names and numbers of the authorizers to the message creator.

If there are no authorizers set up, the creator may be given, for example, this warning: “There are no authorizers setup. Please contact your client care representative to setup call authorizers.” The creator may then be told: “press 1 to repeat, press 2 for the main menu, press 9 to exit.”

Turning now to the authorization criteria 48, or thresholds, that may be set in place in the CPU: The following are examples of criteria that may be used under the present invention to determine if a message that has been created for mass transmission requires the authorization and scrutiny of an individual before it may be sent to mass circulation:

1. A limit may be set as the percentage of a contact type a message creator is allowed to transmit a message to before the rule is broken. Anything less than this percentage will not require authorization. For example, the limit may be set at 20% of a contact type, such as the total number of parents of a school. If a proposed message is for less than that percentage of the total number of parents, the rule is not broken and authorization is not required. If more, then authorization is required.

2. A time window may be set during which a message cannot be transmitted without authorization. For example if it is decided that the limited time window is the antisocial period between 9 pm to 8 am (21:00-08:00 hours military time), then any message created for distribution between those hours would require authorization according to the principles of the invention set forth above.

3. A combination or permutation of any individual rule may be chosen as a new threshold that requires a message to obtain authorization. Thus, for example, the CPU may be configured to allow the management to set an “and” or an “or” combination to individual limitations as a separate rule. For example, if the “and” rule is selected to apply to the rules 1 and 2 above, this means that a message must be identified for sending to 20% or more of that contact type, and between 9 pm and 8 am for a message to require authorization. If the “or” rule is selected, then either sending to 20% or more of that contact type, or sending between 9 pm and 8 am will break the rule and require authorization.

In the manner thus described, the management of a message sending system may configure the system to require a variety of authorization rules or thresholds to be set for later implementation according to the methods set forth above as preferred methods of control and authorization. This represents a barrier to direct transmission, and it prevents simply any unauthorized user from distributing potentially harmful messages. The barrier provides an economical and effective way to control what could otherwise be a potentially hazardous system, in which mistake or mischief could cause widespread panic or harm, and satisfies a need in the art for imposing a control on a powerful and, as yet, unchecked system.

The embodiments have been described in detail with particular reference to certain preferred embodiments, thereof, but it will be understood that variations and modifications may be effected within the scope of the embodiments, especially to those skilled in the art.

We claim:

1. A system for authorizing the mass distribution of a digital message, comprising:
a CPU configured to prepare in digital form a message from an initiator, and to distribute the message to a plurality of recipient contact devices, the CPU being further configured to associate with the message data sets selected by the initiator; and
a database for storing the message and associated data sets,
wherein, the CPU is configured to perform the following functions pending distribution of the message, including:
a. to compare the data sets with a set of authorization criteria, whereby the CPU determines if an authorization threshold has been crossed;
b. to distribute the message if no authorization threshold has been crossed; and
c. to wait for authorization by an individual if any authorization threshold has been crossed, and, thereafter:
1. to distribute the message if authorization is provided; or
2. to not distribute the message if authorization is not provided.

2. The system of claim 1, wherein the data sets include information relating to the type of message that is pending distribution.

3. The system of claim 1, wherein the data sets include information relating to time the message is to be distributed.

4. The system of claim 1, wherein the data sets include information relating to the number of recipients to which the message is to be distributed.

5. The system of claim 1, wherein the data sets include information relating to the number of recipient contact devices to which the message is to be distributed.

6. The system of claim 1, wherein the data include information relating to classification of persons to whom the message is intended for distribution.

7. The system of claim 1, wherein the CPU is further configured to receive a communication from an authorizer.

8. The system of claim 7, wherein the CPU is configured to request the authorizer to enter an identification code before permitting further communication.

9. The system of claim 8, wherein the CPU is configured to receive the identification code by means of telephone dial entry.

10. The system of claim 8, wherein the CPU is configured to receive the identification code by means of voice recognition software.

11. The system of claim 8, wherein the CPU is configured to receive the identification code by means of entry into a text field on a website or application.

12. The system of claim 8, wherein the CPU is configured to receive the identification code by means of an e-mail.

13. The system of claim 8, wherein the CPU is configured to receive the identification code by means of a text message.

14. The system of claim 8, wherein the CPU is configured to permit the authorizer to review a pending message and to review the data sets associated with the message.

15. The system of claim 14, wherein the CPU is configured to permit the authorizer to initiate distribution of the message.

16. The system of claim 14, wherein the CPU is configured to permit the authorizer to block distribution of the message entirely.

17. The system of claim 14, wherein the CPU is configured to permit the authorizer to suspend distribution of the message until a time different than any time for distribution identified in the data.

18. The system of claim 1, wherein the CPU is configured to permit the authorization threshold to be set to comprise the class of information in the data sets.

19. The system of claim 18, wherein the authorization threshold includes timing for sending the message.

20. The system of claim 18, wherein the authorization threshold includes the number of persons intended to receive the message.

21. The system of claim 18, wherein the authorization threshold includes classification of the persons intended to receive the message.

22. The system of claim 18, wherein the authorization threshold includes classification of the type of message intended for distribution,

23. The system of claim 18, wherein the authorization system includes at least two sets of information selected from (a) timing for sending the message, (b) the number of persons intended to receive the message, and (c) classification of the persons intended to receive the message.
